(19) United States
(12) Patent Application Publication
(10) Pub. No.: US 2012/0019486 A1
(43) Pub. Date: Jan. 26, 2012

(54) TOUCH PANEL AND METHOD OF MANUFACTURING THE SAME

(75) Inventors: Sang Hwa Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/952,005

(22) Filed: Nov. 22, 2010

(30) Foreign Application Priority Data
Jul. 23, 2010 (KR) 1020100071499

(51) Int. Cl. G06F 3/042; H01J 9/00

(52) U.S. Cl. 345/176; 445/24

(57) ABSTRACT

Disclosed herein is a touch panel, including: a transparent substrate; a transparent protrusion unit including a patterned partition wall and formed on the transparent substrate; and a transparent electrode formed in the transparent protrusion unit such that it is surrounded by the partition wall. The touch panel is advantageous in that a transparent protrusion unit is employed, and a transparent electrode is formed in the partition wall of the transparent protrusion unit, so that it is possible to prevent the transparent electrode from being scratched and separated during a manufacturing process, thereby improving the durability of the touch panel.

### CROSS REFERENCE TO RELATED APPLICATION

This application claims the benefit of Korean Patent Application No. 10-2010-0071499, filed on Jul. 23, 2010, entitled “Touch panel and a manufacturing method the same”, which is hereby incorporated by reference in its entirety into this application.

### BACKGROUND OF THE INVENTION

1. Technical Field

The present invention relates to a touch panel and a method of manufacturing the same.

2. Description of the Related Art

Development of auxiliary computer devices has taken place alongside the advancement of computers which use digital technology. Personal computers, portable transmitters, and other personal information processing apparatuses carry out the processing of text and graphics using input devices such as keyboards, mice and the like.

However, since computers are gradually being used for various purposes alongside the rapid advance of the information society, there is a problem in that it is difficult to efficiently operate the computers using keyboards and mice which serve as input devices. Therefore, the demand to develop an input device which has a simple structure and does not cause erroneous operations and which can be used to easily input information and data by users is increasing.

Further, input devices must have high reliability, high durability, high innovativeness and high workability in addition to general functionality. In order to accomplish these purposes, a touch panel was developed as an input device capable of inputting information such as text, graphics and the like.

The touch panel is mounted on image display apparatuses, such as flat panel displays including electronic notebooks, liquid crystal displays (LCDs), plasma display panels (PDPs), electroluminescence panels, etc., and cathode ray tubes (CRTs), and is used to enable users to select desired information while viewing an image display apparatus.

Meanwhile, touch panels are classified into resistive touch panels, capacitive touch panels, electromagnetic touch panels, surface acoustic wave (SAW) type touch panels, and infrared touch panels. These various types of touch panels are employed in electronic products in consideration of the problem of signal amplification, the differences of resolution, the difficulty in design and machining techniques, optical characteristics, electrical characteristics, mechanical characteristics, environment-resistant characteristics, input characteristics, durability, and economical efficiency. Currently, among these touch panels, resistive touch panels and capacitive touch panels are the most widely used.

However, conventional resistive touch panels and capacitive touch panels are problematic in that a transparent electrode recognizing the touch of input means is damaged because it protrudes from a transparent substrate. More concretely, the conventional touch panels are problematic in that, since any means for protecting the transparent electrode protruding from the transparent substrate is not provided, the transparent electrode is scratched during a manufacturing process, and is detached from the transparent substrate by the repetitive touch of input means. When the transparent electrode is scratched or is detached from the transparent substrate, the ability of the transparent electrode to recognize the touch of input means is deteriorated, with the result that the sensitivity of a touch panel is deteriorated.

### SUMMARY OF THE INVENTION

Accordingly, the present invention has been devised to solve the above-mentioned problems. The present invention provides a touch panel which can prevent a transparent electrode from being scratched or becoming separated by forming the transparent electrode in the partition wall of a transparent protrusion unit that is additionally used.

An aspect of the present invention provides a touch panel, including: a transparent substrate; a transparent protrusion unit including a patterned partition wall and formed on the transparent substrate; and a transparent electrode formed in the transparent protrusion unit such that it is surrounded by the partition wall.

Here, the transparent electrode may be made of a conductive polymer.

Further, the conductive polymer may include poly-3,4-ethylenedioxythiophene/polystyrenesulfonate (PEDOT/PSS), polyaniline, polyacetylene, and polyphenylenevinylene.

Further, the transparent substrate which is disposed in the partition wall and on which the transparent electrode is formed may be reformed to have hydrophilicity by plasma surface treatment.

Further, the partition wall may have hydrophobicity.

Further, the partition wall may be made of a hydrophobic epoxy resin.

Further, the thickness of the partition wall may be equal to the thickness of the transparent electrode.

Another aspect of the present invention provides a method of manufacturing a touch panel, including: providing a transparent substrate; forming a transparent protrusion unit including a patterned partition wall on the transparent substrate; and forming a transparent electrode in the transparent protrusion unit such that the transparent electrode is surrounded by the partition wall.

Here, in the forming of the transparent protrusion unit, the partition wall may be formed using a dispenser.

Further, in the forming of the transparent electrode, the transparent electrode may be made of a conductive polymer.

Further, the conductive polymer may include poly-3,4-ethylenedioxythiophene/polystyrenesulfonate (PEDOT/PSS), polyaniline, polyacetylene, and polyphenylenevinylene.

Further, the method may further include: performing plasma surface treatment such that the transparent substrate which is disposed in the partition wall and on which the transparent electrode is to be formed has hydrophilicity, before the forming of the transparent electrode.

Further, in the performing the plasma surface treatment, the plasma surface treatment may be performed after a mask provided with an opening corresponding to the partition wall is disposed over the transparent substrate.

Further, in the forming of the transparent protrusion unit, the partition wall may have hydrophobicity.

Further, in the forming of the transparent protrusion unit, the partition wall may be made of a hydrophobic epoxy resin.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a touch panel according to an embodiment of the present invention;

FIG. 2 is a perspective view showing a touch panel according to another embodiment of the present invention;

FIG. 3 is a sectional view showing the touch panel taken along the line A-A′ in FIG. 1;

FIG. 4 is a sectional view showing the touch panel taken along the line B-B′ in FIG. 1;

FIGS. 5 to 8 are sectional views sequentially showing a method of manufacturing a touch panel according to an embodiment of the present invention; and

FIGS. 9 to 11 are sectional views showing touch panels according to other embodiments of the present invention.

### DESCRIPTION OF THE PREFERRED EMBODIMENTS

The objects, features and advantages of the present invention will be more clearly understood from the following detailed description of preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

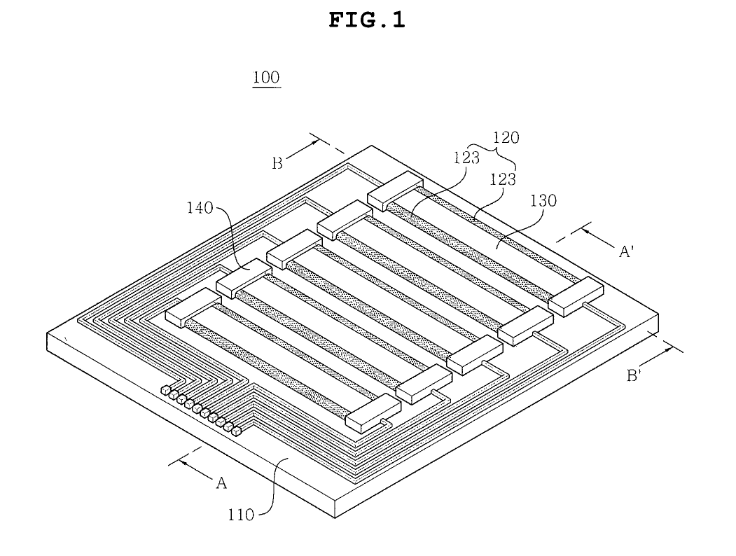

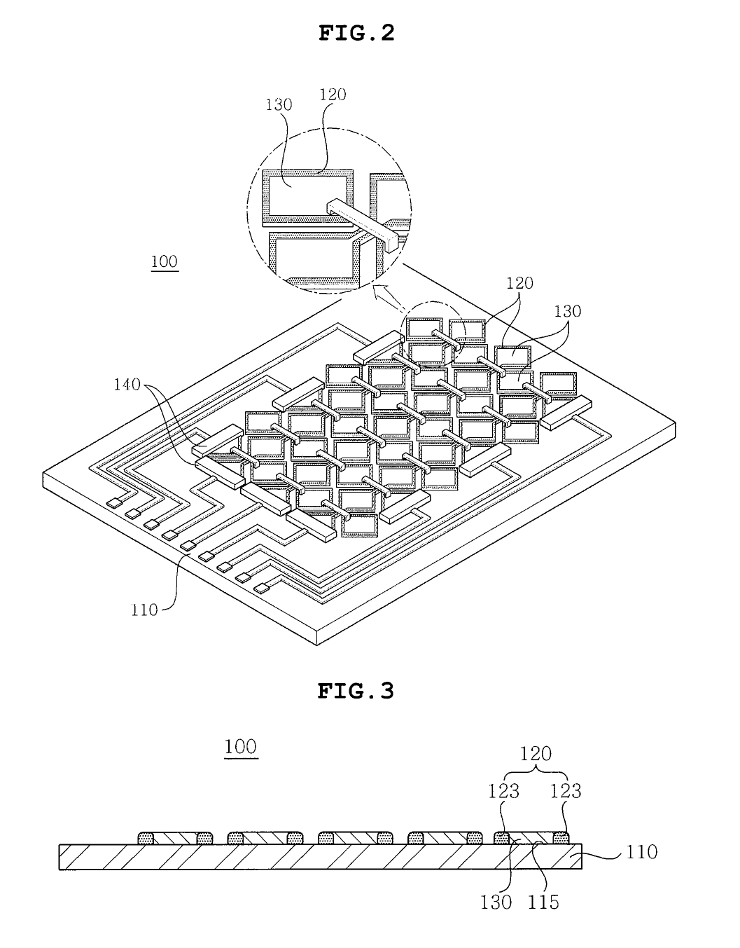

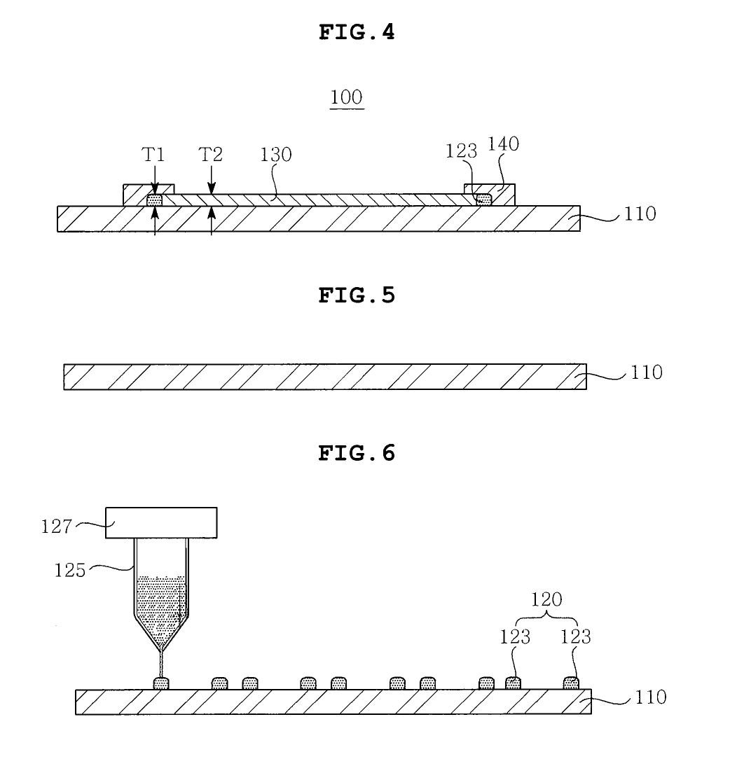

FIG. 1 is a perspective view showing a touch panel according to an embodiment of the present invention, FIG. 2 is a perspective view showing a touch panel according to another embodiment of the present invention, FIG. 3 is a sectional view showing the touch panel taken along the line A-A′ in FIG. 1, and FIG. 4 is a sectional view showing the touch panel taken along the line B-B′ in FIG. 1.

As shown in FIGS. 1 to 4, the touch panel 100 according to an embodiment of the present invention includes: a transparent substrate 110; transparent protrusion units 120, each including a patterned partition wall 123, formed on the transparent substrate 110; and transparent electrodes 130, each of which is formed in the transparent protrusion unit 120 such that it is surrounded by the partition wall 123.

The transparent substrate provides a region for forming the transparent electrodes 130 and the transparent protrusion units 120. The transparent substrate includes an active region and a bezel region partitioned thereon. Here, the active region is a region in which the transparent electrodes 130 recognizing the touch of input means are located, and is disposed at the center of the transparent substrate 110. The bezel region is a region in which electrode wirings 140 electrically connecting with the transparent electrodes 130 are located, and is disposed at the edge of the transparent substrate 100. In this case, the transparent substrate 110 must have supportability such that it can support the transparent electrodes 130 and the transparent protrusion units 120 and must have transparency such that users can recognize the images supplied from an image display apparatus. Considering the supportability and transparency, the transparent substrate 110 may be made of polyethylene terephthalate (PET), polycarbonate (PC), polymethylmethacrylate (PMMA), polyethylene naphthalate (PEN), polyether sulfone (PES), cycloolefin copolymer (COC), triacetylcellulose (TAC), polyvinyl alcohol (PVA), polyimide (PI), polystyrene (PS), K-resin-containing biaxially-oriented polystyrene (BOPS), glass, reinforced glass, or the like, but the present invention is not limited thereto. Furthermore, the transparent substrate 110 may be high-frequency-treated or primer-treated in order to improve adhesion between the transparent substrate 110 and the transparent electrodes 130.

Each of the transparent protrusion units 120, which serves to protect each of the transparent electrodes 130 buried therein, is formed such that it protrudes from the transparent substrate 110. Here, the transparent protrusion unit 120 includes a patterned partition wall 123, and the partition wall 123 is formed such that it surrounds the transparent electrode 130 using a dispenser 125 (refer to FIG. 6). Further, as will be described later, the partition wall 123 may be made of a hydrophobic material in order to accurately form the transparent electrode 130 therein. Furthermore, the partition wall 123 must have transparency as well as hydrophobicity, such that users can recognize the images supplied from an image display apparatus. Therefore, the partition wall 123 may be made of a hydrophobic epoxy resin or the like.

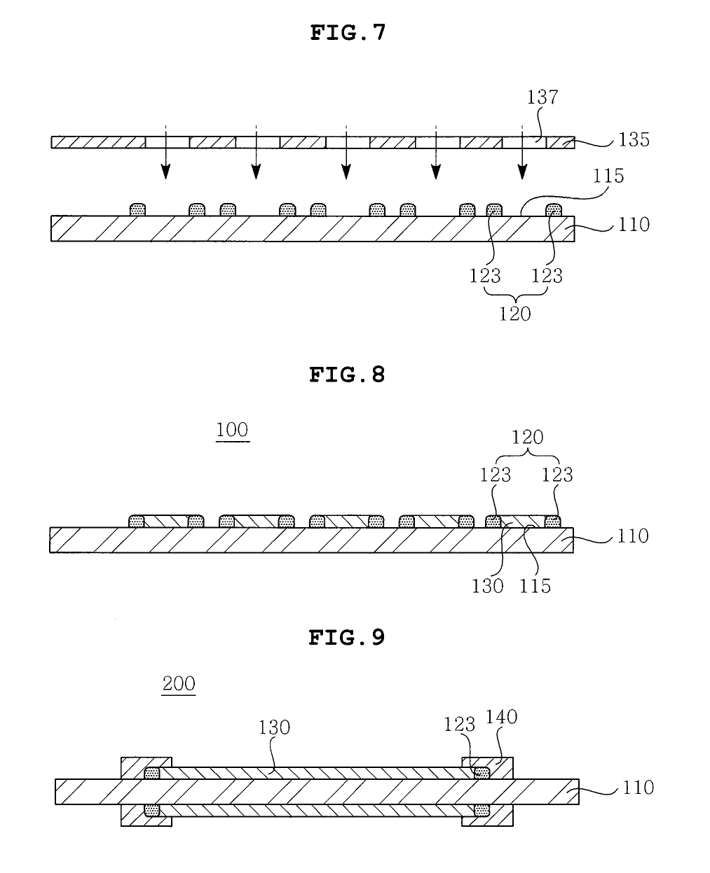

The transparent electrode 130, which serves to enable a controller to generate signals when a user touches it such that it can recognize touch coordinates, is surrounded by the partition wall 123 of the transparent protrusion unit 120. Since the transparent electrode 130 is surrounded and thus protected by the partition wall 123, it is possible to prevent the transparent electrode 130 from being scratched or separated, thus improving the durability of a touch panel. Meanwhile, the transparent electrode 130 may be made of a conductive polymer having excellent flexibility and coatability as well as commonly-used indium tin oxide (ITO). The conductive polymer may include poly-3,4-ethylenedioxythiophene/polystyrenesulfonate (PEDOT/PSS), polyaniline, polyacetylene, polyphenylenevinylene, and the like. Here, when the transparent electrode 130 is made of a conductive polymer (particularly, PEDOT/PSS), it has hydrophilicity. Therefore, as described above, when the partition wall 123 has hydrophobicity, it is possible to prevent the transparent electrode 130 having hydrophilicity from being discharged out of the partition wall 123, and thus the transparent electrode 130 can be accurately formed only in the partition wall 123. Further, since the transparent electrode 130 made of a conductive polymer has hydrophilicity, the transparent substrate 115 disposed in the partition wall 123 is reformed to have hydrophilicity by plasma surface treatment (refer to FIG. 7), so that the transparent electrode 130 is evenly disposed in the partition wall 123, with the result that the transparent electrode 130 can be formed to have uniform thickness.

Hereinafter, the thickness (T2) of the transparent electrode 130 will be compared to the thickness (T1) of the partition wall 123 with reference to FIG. 4. When the thickness (T2) of the transparent electrode 130 is greater than the thickness (T1) of the partition wall 123, the transparent electrode 130 protrudes out of the partition wall 123, and thus it is impossible to prevent the transparent electrode 130 from being scratched. Further, when the thickness (T2) of the transparent electrode 130 is less than the thickness (T1) of the partition wall 123, the transparent electrode 130 is recessed into the partition wall 123, thus deteriorating the ability of the transparent electrode 130 to recognize touch coordinates. Therefore, it is preferred that the thickness (T2) of the transparent electrode 130 be equal to the thickness (T1) of the partition wall 123. Here, the meaning that the thickness (T2) of the transparent electrode 130 is equal to the thickness (T1) of the partition wall 123 is not that the thickness (T2) of the transparent electrode 130 is mathematically completely equal to the thickness (T1) of the partition wall 123 but that the slight change in thickness between the transparent electrode 130 and the partition wall 123, attributable to the processing errors occurring during a manufacturing process, is allowable.

Meanwhile, in drawings, the transparent electrode 130 has a bar pattern (refer to FIG. 1) or a lozenge pattern (refer to FIG. 2), but the scope of the present invention is not limited thereto. That is, the transparent electrode 130 may have any kind of patterns known in the related field.

Meanwhile, an electrode wiring 140 receiving electrical signals from the transparent electrode 130 is printed on the edge of each of the transparent electrodes 130. Here, the electrode wiring 140 may be made of silver paste or organic silver having high electrical conductivity, but the present invention is not limited thereto. That is, the electrode wiring 140 may also be made of conductive polymers, carbon black (including CNT), metal oxides such as ITO, or low-resistance metals.

FIGS. 5 to 8 are sectional views sequentially showing a method of manufacturing a touch panel according to an embodiment of the present invention.

As shown in FIGS. 5 to 8, the method of manufacturing a touch panel according to an embodiment of the present invention includes: (A) providing a transparent substrate 110; (B) forming transparent protrusion units 120, each having a patterned partition wall 123, on the transparent substrate; and (C) forming a transparent electrode in each of the transparent protrusion units 120 such that the transparent electrode is surrounded by the partition wall 123.

First, as shown in FIG. 5, the transparent substrate 110 is provided. Here, the transparent substrate 110, which provides a region for forming the transparent electrodes 130 and the transparent protrusion units 120, must be able to support the transparent electrodes 130 and the transparent protrusion units 120 and must be transparent such that users can recognize the images supplied from an image display apparatus.

Subsequently, as shown in FIG. 6, the transparent protrusion units 120, each having a patterned partition wall 123, are formed on the transparent substrate 110. Here, the partition wall 123 is formed using a dispenser 125, and the dispenser 125 patterns the partition wall 123 while being moved by a driving unit 127. Further, after the partition wall 123 is formed using the dispenser 125, the partition wall 123 is cured by heat treatment. Meanwhile, when the transparent electrode 130, which will be formed later, has hydrophilicity, the partition wall 123 may be made of a hydrophobic material, for example, a hydrophobic epoxy resin in order to prevent the transparent electrode 130 from being discharged out of the partition wall 123.

Subsequently, as shown in FIG. 7, plasma surface treatment is performed such that the transparent substrate 115, which is disposed in the partition wall 123 and on which transparent electrode 130 is located, has hydrophilicity. The plasma surface treatment is needed when the transparent electrode 130, which will be formed, has hydrophilicity. That is, the transparent substrate 115 disposed in the partition wall 123 is reformed to be imparted with hydrophilicity by plasma surface treatment, so that the transparent electrode 130 having hydrophilicity is evenly disposed in the partition wall 123, with the result that the transparent electrode 130 can be formed to have uniform thickness. Meanwhile, in order to perform the plasma surface treatment only on the transparent substrate 115 disposed in the partition wall 123, the plasma surface treatment may be performed after a mask 135 provided with openings 137 corresponding to the partition walls 123 is disposed over the transparent substrate 110.

Subsequently, as shown in FIG. 8, the transparent electrode 130 is formed in each of the transparent protrusion units 120 such that the transparent electrode 130 is surrounded by the partition wall 123. Here, the transparent electrodes 130 may be made of a conductive polymer, such as poly-3,4-ethylenedioxythiophene/polystyrenesulfonate (PEDOT/PSS), polyaniline, polyacetylene, polyphenylenevinylene or the like, as well as commonly-used indium tin oxide (ITO). In this case, when the transparent electrode 130 is made of a conductive polymer (particularly, PEDOT/PSS), it has hydrophilicity. Therefore, the transparent electrode 130 can be accurately formed only in the partition wall 123 because the transparent electrode 130 having hydrophilicity is not discharged out of the partition wall 123. Further, since the transparent substrate 115 disposed in the partition wall 123 was previously reformed to be imparted with hydrophilicity by the plasma surface treatment, the transparent electrode 130 is evenly disposed in the partition wall 123, so that the transparent electrode 130 can be formed to have uniform thickness.

Meanwhile, since the transparent electrode 130 must be formed only in the partition wall 123, it may be formed using a direct patterning process such as screen printing, gravure printing, inkjet printing or the like. However, since only the transparent substrate 115 disposed in the partition wall was reformed to have hydrophilicity, finally, the transparent electrode 130 is formed only in the partition wall 123 even when the transparent substrate 110 is entirely coated with the transparent electrode 130 having hydrophilicity. Therefore, the transparent electrode 130 can be selectively formed only in the partition wall 123 using a wet process such as sputtering, evaporation or the like

Subsequently, the electrode wiring 140 may be printed on the edge of the transparent electrode 130 by screen printing, gravure printing, inkjet printing or the like (refer to FIGS. 1 and 4).

As shown in FIG. 4, according to the embodiment of the present invention, self capacitive touch panels or mutual capacitive touch panels can be fabricated using the single-layer transparent electrodes 130, and, as described later, various types of touch panels 200, 300 and 400 including the above structure can also be fabricated.

FIGS. 9 to 11 are sectional views showing touch panels according to other embodiments of the present invention.

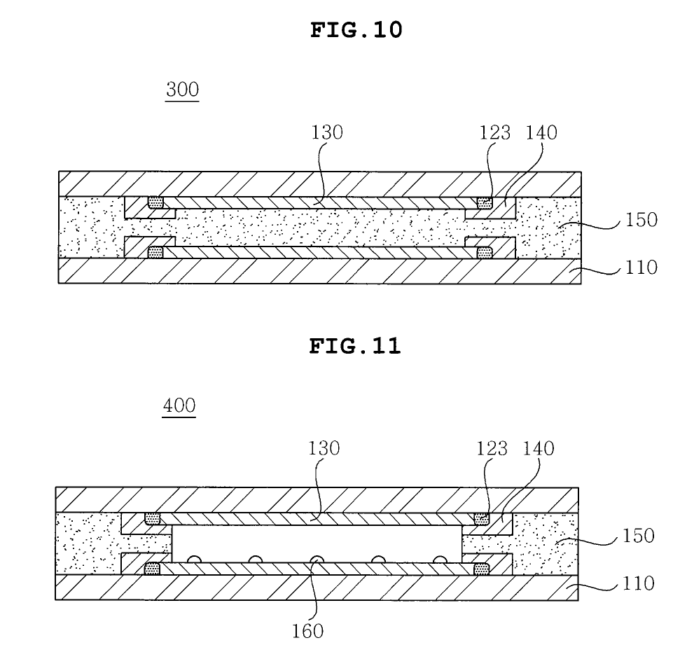

As shown in FIG. 9, a mutual capacitive touch panel 200 (refer to FIG. 9) may be manufactured by forming transparent electrodes 130 on both sides of a transparent substrate 110. Further, as shown in FIGS. 10 and 11, a mutual capacitive touch panel 300 (refer to FIG. 10) and a resistive touch panel 400 (refer to FIG. 11) may be respectively manufactured by attaching two transparent substrates 110, one side of each being provided with transparent electrodes 130, to each other such that the transparent electrodes 130 face each other. Here, in the case of a mutual capacitive touch panel 300 (refer to FIG. 10), an adhesive layer 150 is disposed between two transparent substrates 110 such that the two transparent electrodes 130 facing each other are isolated from each other. In contrast, in the case of the resistive touch panel 400 (refer to FIG. 11), an adhesive layer 150 is disposed only at the edge between two transparent substrates 110 such that the two transparent electrodes 130 facing each other are brought into contact with each other when the resistive touch panel 400 is pressed by a user, and dot spacers 160 are disposed on the exposed surface of each of the two transparent electrodes 130 such that the two transparent electrodes 130 return to their original positions when the pressure applied by the user is removed.

Since each of the touch panels 200, 300 and 400 according to other embodiments of the present invention also includes the transparent protrusion unit 120, and the transparent electrode 130 is formed in the partition wall 123 of the transparent protrusion unit 120, it is possible to prevent the transparent electrode 130 from being scratched and separated during a manufacturing process, thus improving the durability of each of the touch panels 200, 300 and 400.

As described above, the touch panel according to the present invention is advantageous in that a transparent protrusion unit is employed, and a transparent electrode is formed in the partition wall of the transparent protrusion unit, so that it is possible to prevent the transparent electrode from being scratched and separated during a manufacturing process, thereby improving the durability of the touch panel.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A touch panel, comprising:
a transparent substrate;
a transparent protrusion unit including a patterned partition wall and formed on the transparent substrate; and
a transparent electrode formed in the transparent protrusion unit such that it is surrounded by the partition wall.

2. The touch panel according to claim 1, wherein the transparent electrode is made of a conductive polymer.

3. The touch panel according to claim 2, wherein the conductive polymer includes poly-3,4-ethylenedioxythiophene/polystyrenesulfonate (PEDOT/PSS), polyaniline, polyacetylene, and polyphenylenevinylene.

4. The touch panel according to claim 1, wherein the transparent substrate which is disposed in the partition wall and on which the transparent electrode is formed is reformed to have hydrophilicity by plasma surface treatment.

5. The touch panel according to claim 1, wherein the partition wall has hydrophobicity.

6. The touch panel according to claim 5, wherein the partition wall is made of a hydrophobic epoxy resin.

7. The touch panel according to claim 1, wherein the thickness of the partition wall is equal to the thickness of the transparent electrode.

8. A method of manufacturing a touch panel, comprising:
providing a transparent substrate;
forming a transparent protrusion unit including a patterned partition wall on the transparent substrate; and
forming a transparent electrode in the transparent protrusion unit such that the transparent electrode is surrounded by the partition wall.

9. The method according to claim 8, wherein, in the forming of the transparent protrusion unit, the partition wall is formed using a dispenser.

10. The method according to claim 8, wherein, in the forming of the transparent electrode, the transparent electrode is made of a conductive polymer.

11. The method according to claim 10, wherein the conductive polymer includes poly-3,4-ethylenedioxythiophene/polystyrenesulfonate (PEDOT/PSS), polyaniline, polyacetylene, and polyphenylenevinylene.

12. The method according to claim 8, further comprising: performing plasma surface treatment such that the transparent substrate which is disposed in the partition wall and on which the transparent electrode is to be formed has hydrophilicity, before the forming of the transparent electrode.

13. The method according to claim 12, wherein, in the performing of the plasma surface treatment, the plasma surface treatment is performed after a mask provided with an opening corresponding to the partition wall is disposed over the transparent substrate.

14. The method according to claim 8, wherein, in the forming of the transparent protrusion unit, the partition wall has hydrophobicity.

15. The method according to claim 14, wherein, in the forming of the transparent protrusion unit, the partition wall is made of a hydrophobic epoxy resin.
